(19) United States
(12) Patent Application Publication
(10) Pub. No.: US 2015/0275822 A1
(43) Pub. Date: Oct. 1, 2015

(54) SUPERCHARGED PULSE JET ENGINE AND RELATED METHOD OF USE

(71) Applicant: Furness-Newburge, Inc., Versailles, KY (US)

(72) Inventors: James Clinton Furness, JR., Versailles, KY (US); David Adam Brentzel, Lexington, KY (US); Paul David Paulsen, Lexington, KY (US); James J. Powers, IV, Lexington, KY (US)

(21) Appl. No.: 14/665,558

(22) Filed: Mar. 23, 2015

Related U.S. Application Data
(60) Provisional application No. 61/971,789, filed on Mar. 28, 2014.

(51) Int. Cl. F02K 7/06

(52) U.S. Cl. CPC F02K 7/06

(57) ABSTRACT

A system including a supercharged pulse jet engine is disclosed for the separation of a processing fluid. The system may include a rotary valve for introducing pockets of compressed air into the combustion chamber of the engine. Conditions of combustion may be adjusted in order to create “squared waves” within the exhaust to aid in separation. The processing fluid may be introduced into the exhaust stream of the engine, which may vaporize the process fluid, allowing compounds dissolved or suspended to be separated therefrom. The system may include a heat recovery system for pretreating the process fluid to conserve energy. Additionally, one or more separation elements such as an auger, a conveyor, a dust collector, a cyclone, or the like may be used to collect compounds separated from the process fluid. A condenser may be used to collect the fluid portion of the process fluid after separation.

This application claims the benefit of U.S. Provisional patent application Ser. No. 61/971,789 filed on Mar. 28, 2014.

### TECHNICAL FIELD

This disclosure relates generally to a supercharged pulse jet engine and to a method of using the same to separate liquid from particles suspended and/or dissolved therein.

### BACKGROUND OF THE INVENTION

Pulse jet engines normally operate using one of two configurations. The first is the valved engine, which uses a one-way valve such as a flapper valve to regulate the inflow of air through the intake and direct the exhaust through the tailpipe. The second configuration utilizes a valveless design, which may include no moving parts, but rather utilizes the geometry of the engine to direct air in through the inlet and exhaust through the outlet. Pulse jet engines operate in a manner known in the art, wherein a mixture of fuel and air are introduced into a combustion chamber and ignited, wherein the combusted byproducts and air are directed out of the engine, creating a thrusting pulse.

In use, a sequence of cycles of the engine produces a series of high pressure followed by low pressure periods within the combustion chamber and at the outlet of the engine. This may be visually seen in the pressure vs. time graph of FIG. 1, illustrating pressure measurements taken at the outlet point of a pulse jet engine. The peaks and valleys of the waveform illustrate pressure created by the ignition of the fuel and the vacuum left after the ignition, respectively.

### SUMMARY OF THE INVENTION

An object of the disclosure is to provide a pulse jet engine with a supercharger as a novel valve configuration. The supercharger may include a rotating valve and a high pressure source attached thereto.

An additional object of the disclosure is to introduce a compound including a liquid and at least one component dissolved or suspended therein and using the exhaust point of the pulse jet engine to separate the liquid from the dissolved or suspended component. This compound may be in any of a plurality of forms, such as well drilling clay and liquids, such as from the hydraulic fracturing industry, wastewater sludges, foundry clay, foundry sands, wastewater associated with wastewater treatment facilities, and water for drinking or irrigation purposes.

According to one embodiment of the present invention, an apparatus is disclosed for creating an exhaust stream for separating a fluid from a compound suspended or dissolved therein. The apparatus may comprise a pulse jet engine and a rotary valve for selectively introducing pressurized pockets of air into the pulse jet engine.

The pulse jet engine may include a combustion chamber and an exhaust section, and the compressed pockets of air may be introduced into the combustion chamber. The combustion chamber and the exhaust section may be generally circular in cross-section. In one aspect, a diameter of the combustion chamber may be different in size than a diameter of the exhaust section, such as for example, the diameter of the combustion chamber may be larger than the diameter of the exhaust section. There may be a smooth transition from the larger diameter to the smaller diameter.

The apparatus may further include an injector for mixing fuel with the pressurized pockets of air prior to introduction into the pulse jet engine. The injection may include a conduit with a non-circular cross-sectional shape. In one instance, the cross-section may include a plurality of lobes, such as, for example, including a floraform cross-sectional shape.

In one aspect, the rotary valve may include a rotor with a passage therethrough for selectively allowing pressurized air into the pulse jet engine. The passage may be longer in an axial direction than in a circumferential direction.

In another aspect, the rotary valve may include an ignition system for selectively controlling and/or firing an igniter associated with the pulse jet engine. The ignition system may comprise a magnet and a magneto coil. One of the magnet and the magneto coil may be in a fixed position relative to the rotary valve, and the other of the magnet and the magneto coil may be adapted to move with the rotor. Rotation of the rotary valve may cause movement of one or the other of the magnet and the magneto coil such that relative motion between the magnet and the magneto coil generates sufficient voltage to cause the igniter to ignite.

The apparatus may further include a nozzle for introducing the fluid and the compound suspended or dissolved therein into the exhaust stream from the pulse jet engine for separation. The nozzle may be in the form of a spray nozzle, a misting nozzle, or any other instrument capable of introducing the fluid and compound into the exhaust stream.

In another embodiment, the invention relates to a system for separating a fluid component from a process fluid, wherein the process fluid includes the fluid component and at least one other component. The system may include a pulse jet engine including a combustion chamber and an exhaust, a rotary valve for introducing pockets of pressurized air into the combustion chamber, a fuel injection system for mixing fuel with the pressurized pockets of air prior to entering the combustion chamber, and at least one conduit for introducing the process fluid into an exhaust stream at the exhaust of the pulse jet engine.

The system may further include one or more heat exchangers for recovering heat created by the system. For example, at least one first heat exchanger may be associated with the pulse jet engine for recovering heat created during combustion. The system may additionally include at least one second heat exchanger associated with the at least one conduit for preheating the process fluid prior to entering the exhaust stream.

In addition, the system may include at least one controller for controlling one or more of the rotary valve, the fuel injection system, and a flow rate of the process fluid through the at least one conduit. A single controller may be used to control and coordinate each of these aspects of the system.

Furthermore, the system may include a chamber for receiving the process fluid after it has been separated into the fluid component and the at least one other component by the exhaust stream. This chamber may be insulated to retain heat and prevent recondensation of the fluid component after it has been vaporized in the exhaust stream. The chamber may include a solids collection device for collecting the at least one other component separated from the process fluid. In another aspect, the system may further include a pressurizing device for drawing the fluid component separated from the process fluid from the chamber. For example, the pressurizing device may comprise a blower for directing vaporized fluid from the chamber. A dust collection device may additionally be included in the system for removing airborne particles from the vaporized fluid.

In a further embodiment, a system is disclosed for creating an exhaust stream for separating a fluid from a compound suspended or dissolved therein. The system may include a pulse jet engine including a combustion chamber and an exhaust, a rotary valve for introducing pockets of pressurized air into the combustion chamber, a fuel injection system for mixing fuel with the pressurized pockets of air prior to entering the combustion chamber, and an air inlet control system for controlling a flow rate of air introduced to the rotary valve.

In one aspect, the air inlet control system may include a controller for varying the flow rate of air based on a temperature of the pulse jet engine. The air inlet control system may include at least two airflow pathways, and wherein the controller is adapted to selectively direct air through one or more of the pathways in response to a change in the temperature of the pulse jet engine. In one aspect, the air inlet control system includes three airflow pathways, with each pathway including a different valve for allowing a different amount of air to reach the rotary valve. The valves may be any of a manual valve, a needle valve, or a solenoid valve. The controller may be adapted to selectively control airflow through one or more of these airflow paths. This may allow firing of the engine to be gradually and/or incrementally increased from idle, to a middle firing range, to full throttle.

### BRIEF DESCRIPTION OF THE DRAWINGS

FIG. 1 is a graph of pressure vs. time created by a traditional pulse jet engine;

FIG. 2 is a top plan view of a supercharged pulse jet engine of one embodiment of the present invention;

FIG. 3 is a side elevation view of the supercharged pulse jet engine of FIG. 2 along the line A-A;

FIG. 4a is a cross-sectional view of a conduit at the injector;

FIG. 4b is a bottom view of the injector as seen through line B-B of FIG. 4a;

FIG. 4c is a side elevation view of the conduit at the injector;

FIG. 5a is a perspective view of the rotary valve of the present invention;

FIG. 5b is a cross-sectional view of the rotary valve of FIG. 5a;

FIG. 5c is an exploded view of the rotary valve of FIG. 5a;

FIG. 6 is a graph of pressure vs. time illustrating the pressure wave created by the present invention;

FIGS. 7a-7c illustrate various views of one embodiment of the nozzle of the present invention;

FIG. 8 is a perspective view of a drying element used in combination with the supercharged pulse jet engine of the present invention;

FIG. 9 is a schematic of a separation system using a supercharged pulse jet engine in one embodiment of the present invention; and

FIG. 10 is a schematic of an embodiment of the air inlet control system of the system of FIG. 9.

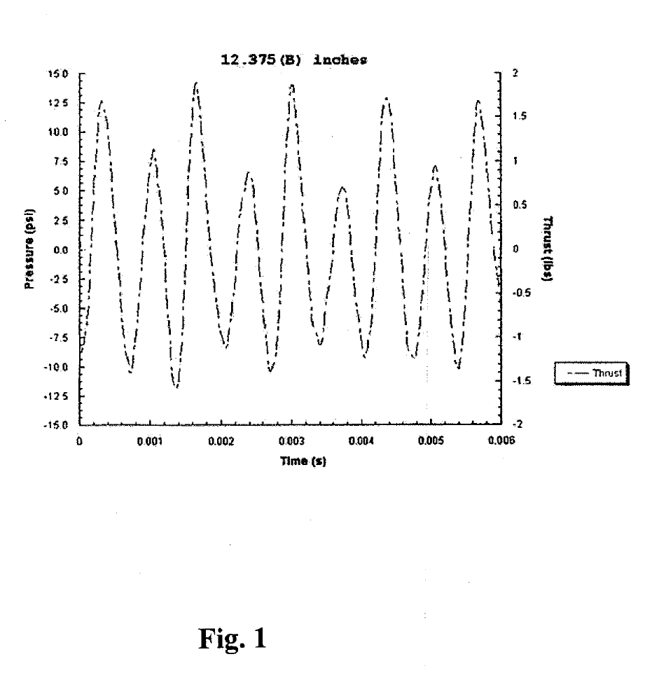

### DETAILED DESCRIPTION OF THE INVENTION

The description provided below and in regard to the figures applies to all embodiments unless noted otherwise, and features common to each embodiment are similarly shown and numbered.

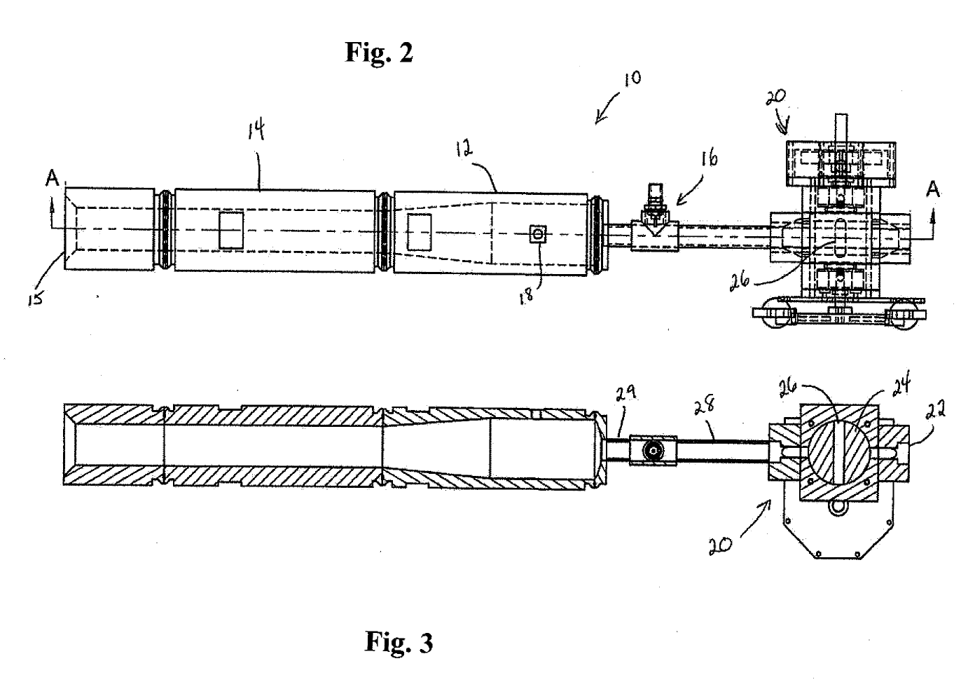

FIG. 2 illustrates a supercharged pulse jet engine 10 according to an embodiment of the present invention. The engine 10 may include a resonant combustion chamber 12 and an exhaust section 14 for diverting the exhaust from the engine 10. The combustion chamber 12 and the exhaust section 14 may be machined in segments from a solid round billet of a high temperature alloy such as stainless steel, or an austenite nickel-chromium-based superalloy such as Inconel.

The engine 10 may take the form of an elongate cylinder with a first inner diameter of the combustion chamber 12 and a second inner diameter of the exhaust section 14. In one aspect, the first inner diameter of the combustion chamber 12 may be larger than the second inner diameter of the exhaust section 14. As illustrated in FIG. 2, the engine 10 may include a transition from the first diameter to the second diameter, such as, for example, a constant smooth transition from the first diameter to the second diameter. The exhaust section 14 may further open into a mouth 15. In one aspect, the mouth 15 may be beveled so as to taper from a smaller inner diameter of the exhaust section 14 to a larger inner diameter at an exhaust aperture.

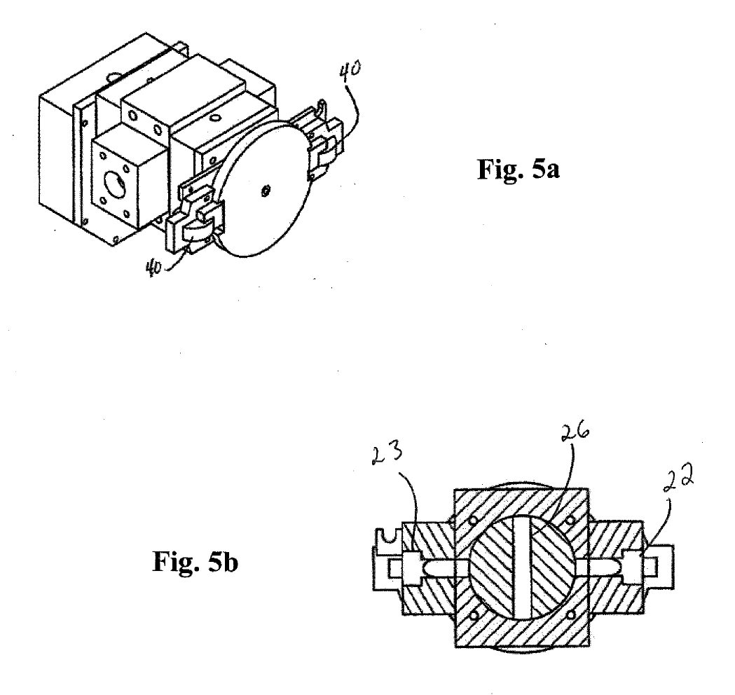

In addition, an injector 16 may be provided for introducing fuel into the engine 10, as illustrated in further detail in FIGS. 4A-4C. The combustion chamber may include an igniter 18, such as a spark plug for igniting the combustible fuel mixture that enters the combustion chamber 12.

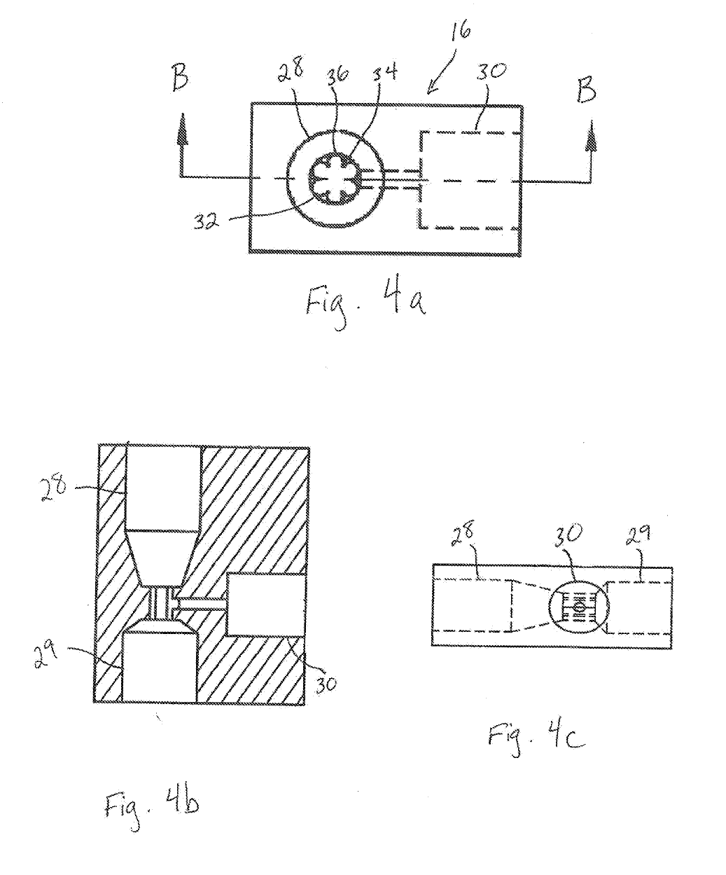

The engine 10 may further be provided with a valve, such as a supercharger rotary valve 20. With further reference to FIG. 3, the rotary valve 20 may include an inlet 22 for allowing high pressure air to enter the valve 20. The inlet 22 may be connected to a high pressure air source such as a compressor (not pictured) for the introduction of the high-pressure air. For example, the high-pressure air may be introduced into the inlet 22 at approximately 80-200 psi.

Additionally, the rotary valve 20 may include a rotating element such as rotor 24. The rotor 24 may include a passage 26 for allowing air from the inlet 22 to pass through the valve 20. In operation, the rotor 24 may rotate such that the passageway 26 allows high pressure air to flow through the valve 20 only when the passageway 26 aligns with the inlet 22 and an outlet 23 of the rotary valve 20. In one aspect, the passage 26 may include apertures on opposing sides of the rotor 24, said apertures connected by parallel sidewalls through the rotor 24. The apertures may include an elongate profile with a width greater than a height, such as having an oval or rectangular shape. During constant-speed rotation of the rotor 24, the apertures may be dimensioned such that at least a portion of at least one of the apertures is aligned with the inlet 22 and the outlet 23 during only a fixed percentage of operation. For example, the apertures may be dimensioned to at least partially align with the inlet 22 and the outlet 23 during less than 30% of a given rotation of the rotor 24.

The rotary valve 20 may be connected to the combustion chamber 12 by at least one first conduit 28. The injector 16 may be positioned between the rotary valve 20 and the combustion chamber 12. High pressure air traveling from the rotary valve 20, through the first conduit 28, may be mixed with fuel by the fuel injector, and the fuel/air mixture may be transferred through a second conduit 29 into the combustion chamber 12.

With reference to FIGS. 4a-4c, the injector 16 is further detailed. The injector 16 may comprise a novel eductor and may include a fuel conduit 30 for introducing the fuel into the first conduit 28 and for combining said fuel with the high pressure air proceeding through the rotary valve 20. The fuel conduit may be perpendicular to the first conduit 28. At the point at which fuel is introduced to the first conduit 28, the air/fuel mixture may be mixed in an air/fuel conduit 32. The air/fuel conduit 32 may be smaller in diameter than the first conduit 28. The air/fuel conduit 32 may further connect the first conduit 28 to the second conduit 29. In one aspect, the air/fuel conduit 32 may include a cross-section 34 that is non-circular in shape. For example, as illustrated in FIG. 4a, the cross-section 34 of the air/fuel conduit 32 may include a plurality of lobes 36. The lobes 36 may be rounded and arranged around a central axis and may form a floraform. The non-circular cross section 34 may serve to enhance or increase turbulence in the fuel/air mixture prior to and upon entry of the combustion chamber 12.

In a further aspect, ozone may be introduced with the fuel. Introduction of ozone may be done through the injector 16. The presence of ozone may enhance oxidation of organic contaminants and/or improve fuel efficiency.

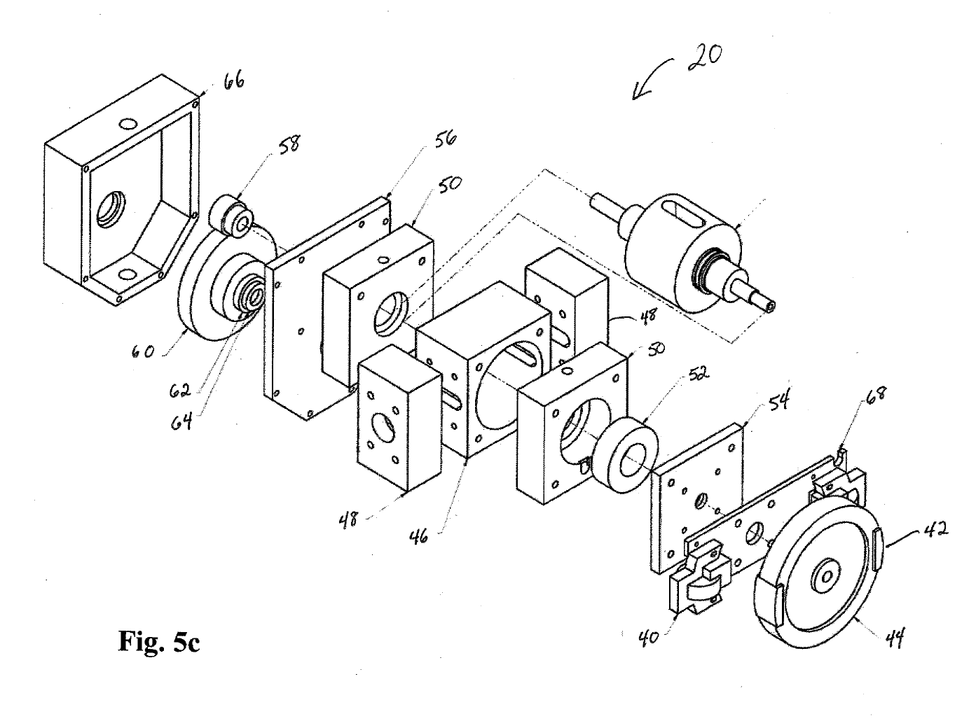

FIGS. 5a-5c illustrate the rotary valve 20 in further detail. The valve 20 may include an ignition system for activating the igniter 18. The ignition system may be integral with the valve 20. The ignition system may comprise one or more magneto coils 40 that may be mounted in fixed positions, such as on a fixed housing. These fixed positions may align with the inlet 22 and/or the first conduit 28. The valve 20 may include one or more magnets 42 that may be aligned with the passage 26. These magnets 42 may be attached to a flywheel 44, which may be designed to rotate with the rotor 24. As the rotor 24 turns, the magnets may move past the magneto coil, thereby inducing the voltage necessary to cause the igniter 18 to fire. The arrangement of the magneto coil(s) 40 and the magnets 42 may be such that the voltage necessary to ignite the igniter 18 occurs at the point in the cycle that the passage 26 allows high pressure air to flow from the inlet 22 through the passage 26 and the first conduit 28. The position of the magnets 42 and/or the magneto coil(s) 40 may be adjusted to optimize the timing of the firing of the igniter 18. For example, an angular position of the flywheel 44 relative to the slot can be adjusted in order to adjust the spark timing.

With further reference to FIG. 5c, an exploded figure of the valve 20 is illustrated. The rotor 24 may be cylindrical in nature and may be housed inside a rotor housing 46, which may allow the rotor to rotate therein. The rotor housing 46 may include one or more slots 47 for aligning with the passage 26 of the rotor 24. The rotor housing 46 may be surrounded by one or more adaptors 48, which are designed to connect the slot-shaped passage of the rotor to the inlet 22 of the valve 20 and the first conduit 28, respectively. The rotor housing 46 may be associated with one or more bearing holders 50, which may be adapted to retain one or more bearings 52 for allowing the rotor 24 to rotate. One or more of the bearings 52 and related bearing holders 50 may be tapered. The bearing holders 50 may be retained to the housing 46 by way of an end cap 54 and a backing plate 56. The valve 20 may further include a pinion 58 associated with the rotor 24, which may be driven by a gear 60, which may in turn be driven by a motor (not pictured). In one aspect, the motor may be a variable speed electric motor. The gear 60 may include one or more gear bearings 62 and shaft seals 64 to ensure adequate and efficient rotation.

The valve 20 may be equipped with a mount 68 for a proximity switch (not pictured), which may allow for precise measurement of the instantaneous valve speed. This data from the proximity sensor may be delivered to a data acquisition and control system for monitoring and adjusting the rotational speed of the rotor 20. The speed of the valve may be matched to the geometry of the combustion chamber 12 and exhaust section 14 such that a reflected pressure wave from a previous combustion cycle arrives from the exhaust section 14 at the same time as the inrush of fuel and air from the injector 16, providing compression to enhance the combustion of the new fuel-air charge within the combustion chamber 12.

In practice, the engine is adapted to combine the use of the combustion chamber 12 and exhaust section 14 with the high speed, pressurized rotary air valve 20 to control and deliver pressurized “packets” of air into the combustion chamber. Through control of the speed of the rotary valve 20, the pressure of the air introduced therethrough, and the size and shape of the passage 26, the “packets” of air may be manipulated in shape, speed, and intensity. This control may be accomplished by the use of a controller such as a computer or microprocessor.

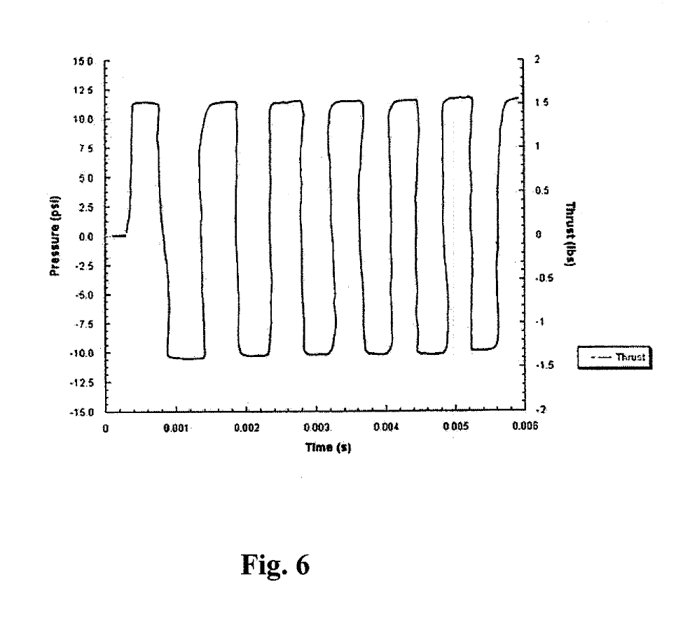

Detonation of the fuel/air mixture in the combustion chamber 12 in combination with the pressurized “packets” of air may create supersonic pressure spikes at the mouth 15 of the exhaust section 14. As shown in FIG. 6, the combination of high pressure rotary valve and engine and valve configuration described herein, allows for the pressure created by the pulse jet engine at the mouth 15 to approximate a squared wave. The controlled high pressure rotary valve 20 in combination with the injector and the detonation of the fuel/air mixture allows the “sharpening” of the waves, thereby creating a squared wave as opposed to a sinusoidal wave. These squared waves may include very sharp positive and deep negative pressure pulses. The positive pressures may reach approximately 8-20 psi and the negative pressure may reach approximately 8-11 negative psi. The squared waves and exhaust may travel in a direction generally parallel to a longitudinal axis of the engine 10. Significant process enhancing ultrasonic energy can result.

Introduction of a process fluid such as a liquid including a dissolved or suspended component may allow for the use of the supercharged pulse jet engine to separate the liquid from the dissolved or suspended component within. In the context of this disclosure, the process fluid may comprise a liquid, a slurry with low or high solids content, or solids with at least some moisture content to be separated therefrom. The separation may include atomization, electrical charging, desalination and/or evaporation. For example, the supercharged pulse jet engine may be utilized to separate an aqueous slurry into water and the component(s) suspended therein. This may be accomplished by introducing the slurry or compound at the mouth 15 of the engine 10. The supersonic pressure spike associated with the detonation of each air/fuel charge may atomize the slurry, thereby greatly increasing its surface area. The heat of combustion associated with the detonation and the rebound vacuum created by the overexpansion of the exhaust gas after combustion work together to vaporize the liquid of the slurry quickly and efficiently. The combination of the heat of combustion and the supersonic shock wave caused by the detonation of the air/fuel mixture may force some or all of the liquid from the compound into a supercritical state. This supercritical state may cause the suspended component to fall out of suspension and/or the dissolved component to separate from the liquid or slurry. Additionally, the use of ozone and/or peroxide may result in accelerated advanced oxidation reactions in the presence of the shock wave. The ozone and/or peroxide may be introduced to the liquid in advance of introducing the liquid into the exhaust, such as in the reservoir.

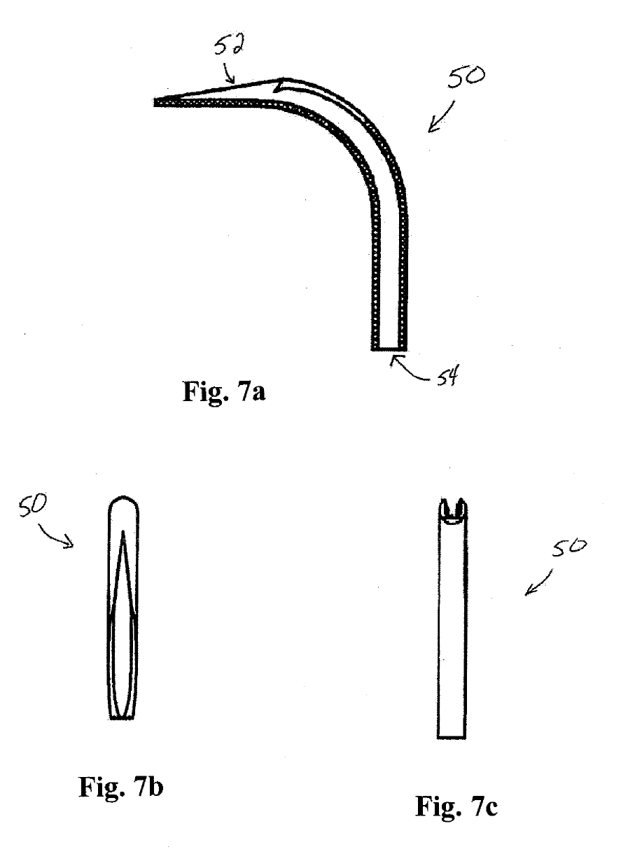

With further reference to FIGS. 7a-7c, a nozzle 70 is disclosed for introducing the liquid or slurry for separation. The nozzle 70 may be positioned at or near the mouth 15 of the engine 10. For example, the nozzle 70 may be placed outside the mouth 15 of the exhaust section 14, and may be placed within the path of exhaust exiting the engine 10. The nozzle 70 may include an inlet 72 that may be connected to a reservoir (not pictured), for supplying the liquid for separation. A pump (not pictured) may be provided for metering the liquid or slurry for separation through the nozzle 70.

In addition, at least one transfer conduit (not pictured) may be adapted to connect the reservoir to the nozzle 70. This transfer conduit may be adapted recover at least some heat from the combustion within the combustion chamber 12. For example, the transfer conduit may be positioned in contact with or on close proximity to the combustion chamber 12. In one instance, the transfer conduit may be wrapped around the combustion chamber 12. The heat recovered from the combustion chamber 12 may be used to “pre-heat” the liquid or slurry before it reaches the nozzle 70. Such pre-heating may be used when evaporation of the liquid is the desired outcome. In addition, the entire unit, including the engine 10 and the nozzle 70) may be enclosed in an evaporator and/or exposed to a vacuum to enhance evaporation. In the case of the goal being to collect the liquid from the liquid/suspended (or dissolved) compound mixture, the transfer conduit may be separated from the combustion chamber 12 in order to prevent the liquid to be separated from becoming overheated.

As illustrated in FIG. 7a, the nozzle 70 may further include an outlet 74 for introducing the liquid or slurry into the path of the exhaust from the engine 10. The nozzle 70 may be curved in shape. The outlet 74 may comprise an elongated aperture along the nozzle 70. As seen in FIGS. 7b and 7c, this aperture may include a V-shaped profile. This elongated aperture may create a large surface area through which the liquid or slurry may be drawn into the path of the squared wave exhaust exiting the mouth 15 of the engine 10. In alternate embodiments, the nozzle 70 may be in the form of a misting nozzle, a spray nozzle, or any other element capable of introducing the liquid into the path of the exhaust from the engine.

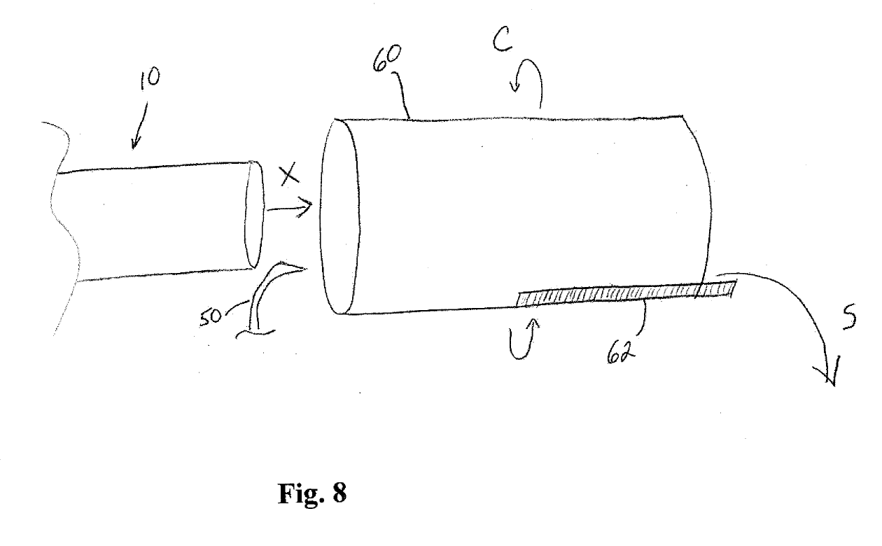

The supercharged pulse jet engine 10 may further be used in association with a drying element, such as rotating dryer 80, as illustrated in FIG. 8. The rotating dryer 80 may be in the form of a tube. The dryer 80 may also include solid or perforated walls, such as a tube including a plurality of slits and/or apertures in a surface thereof. The nozzle 70 may be placed in proximity to the engine 10 such that the liquid and dissolved and/or suspended compound may be separated as described herein. The exhaust from the engine 10 may travel in a direction X, and may be directed into the dryer 80, which may be rotated in a direction C, such as by a motor (not pictured). The rotation of the dryer 80 creates centrifugal forces within the dryer 80, thereby allowing the compound, now at least partially separated from the liquid by the engine 10, to collect on the dryer 80. In one aspect, a collector, such as wiper 82, may be used to collect the at least partially separated or dried compound from the dryer 80. The wiper 82 may be fixed in a given position, such as a stationary position within the dryer 80, such that the at least partially separated or dried compound may be continuously wiped or scraped from the wall of the dryer. The compound may be collected as a slurry S to be further processed or disposed.

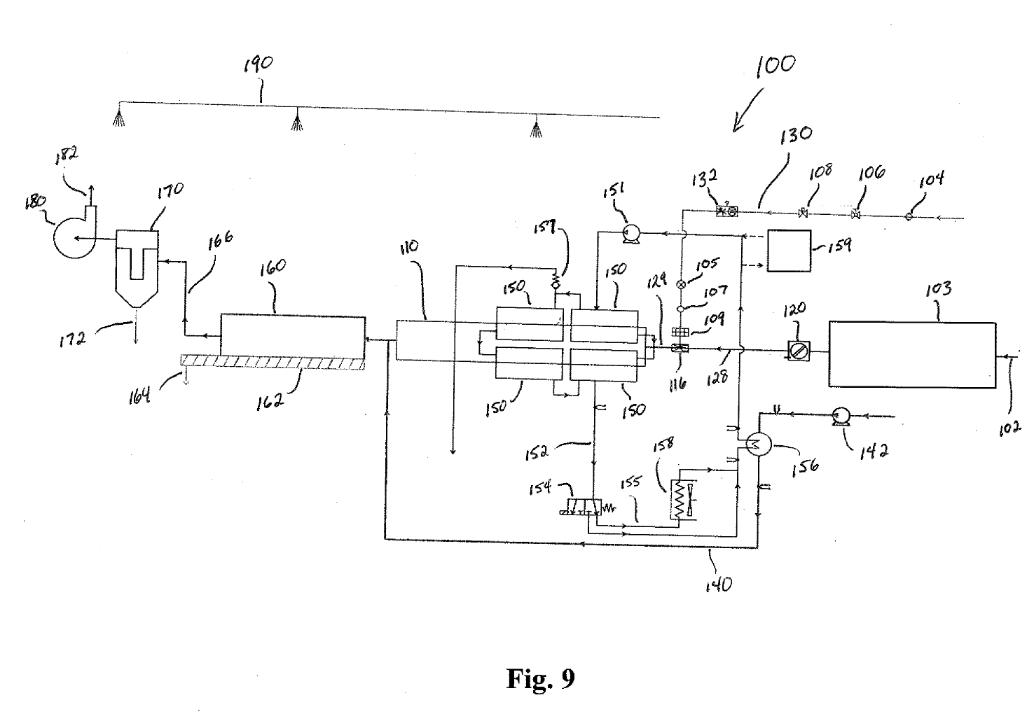

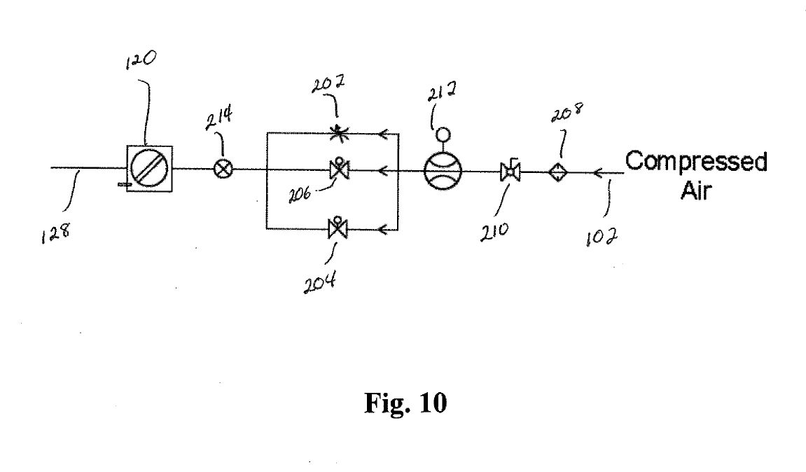

In one aspect of the present invention, as illustrated in FIG. 9, a system 100 is disclosed for supercharging a pulse jet engine 110 for utilization in separation of a process fluid. The system may include air inlet conduit 102 for receiving and transporting the pressurized air. The pressurized air may be regulated by an inlet control system 103 (as further described with respect to FIG. 10, below) for variably controlling the airflow to the supercharging rotary valve 120. Pressurized pockets of air may then pass through a first conduit 128 to be introduced into the engine 110, as described above.

The system may further include a fuel line 130 for introducing fuel from a reservoir (not pictured) into the system, wherein the flow of said fuel may be controlled by a fuel pump 132. The fuel may pass through one or more filters 104, and the flow of fuel may further be regulated by one or more manual valves 106 and/or solenoid valves 108. The fuel line may further include one or more pressure sensors 105 and safety features such as a check valve 107 for limiting the direction of fuel flow, as well as a flame arrestor 109 for preventing the exposure of any flame to the fuel line. The flow of fuel, such as through the fuel pump 132 and/or the solenoid valve 108 may be controlled by a computer or other controller (not pictured).

Fuel from the fuel line 130 and air from the first conduit 128 may be mixed at the injector 116, which may comprise a novel eductor as described herein. This fuel/air mixture may pass through the second conduit 129 to be introduced for combustion in the supercharged pulsed jet engine 110.

A processing fluid to be separated by the system may be introduced through process fluid conduit 140. The flow of the process fluid may be regulated by a process fluid pump 142, which in one embodiment may be controlled by a computer or other controller (not pictured). The process fluid may be introduced at the outlet of the engine 110 in order to separate the liquid from the dissolved or suspended component as described herein. In the case of a process fluid with a high solids content, or in the case of the process fluid constituting a low moisture solid, the system may utilize an auger, belt, or other transfer mechanism to introduce the process fluid into the pulsing stream of hot gasses leaving the exhaust of the engine 110.

The system may further include one or more heat exchangers 150 associated with the engine 110. The heat exchanger(s) 150 may be in the form of a closed jacket filled with high temperature heat transfer fluid (HTF), such as a synthetic hydrocarbon heat transfer fluid, for example Therminol 55. In the illustrated embodiment, a system of four interconnected closed jackets 150 are provided for contacting or surrounding at least a portion of the engine 110. The jackets 150 may be used to regulate the temperature of the engine 110, to preheat the process fluid to be separated, and to recover otherwise wasted heat.

The HTF may be circulated through the heat exchangers 150 and through a heat exchange loop 152, such as via a HFT pump 151. The heat exchange loop may include a first heat exchanger 156 that may be used to transfer heat from the HTF to the process fluid. This may serve to “pre-heat” the process fluid before it is introduced into the engine exhaust for separation.

Additionally, a diverter 154 may be provided for distributing HTF between the heat exchange loop 152 and heat overflow path 155. This heat overflow path 155 may include an overflow heat exchanger 158 which may allow for excess heat to be discharged from the system, such as through a radiator with cooling fans. The precise amount of HTF diverted between the heat exchange loop 152 and the overflow path 155 may be controlled by a computer or other controller, thereby allowing the system to precisely regulate its temperature, should the temperature begin to approach a maximum working temperature of the HTF.

The heat exchange loop 152 may further include an optional branch to a secondary heat collection device 159 in order to prevent the waste of heat from the system.

A pressure release valve 157 may further be included in order to allow pressure to vent, such as to the atmosphere, in the case of the closed heat exchange system becoming over pressurized.

As illustrated in FIG. 10, the air inlet control system 103 may allow for the varied and controlled flow of air to the rotary valve 120, and therefore to the engine 110. This may be useful in the varied amount of air (and fuel) that may be provided to the engine 110 during the start-up procedure. Compressed (supercharged) air may be fed to the rotary valve 120 through one or more of three pathways. These pathways include a first valve 202, such as a needle valve, a second valve 204, such as a small solenoid valve, and a third valve 206, such as a larger solenoid valve, respectively.

Upon initially starting the system, the first valve 202 may be set at a predetermined flow rate and the second and third valves 204,206 may be closed. Pressurized air may be applied to the system through the first valve 202, and rotation of the rotary valve 120 may be initiated. The predetermined air flow rate through the first valve 202 may be sufficient to sustain combustion. At this point, the fuel pump 132 may operate at a first flow rate in order to allow sufficient fuel into the system for the engine 110 to idle. After the engine 110 has idled sufficiently long so that the HTF immediately downstream from the engine 110 (as measured by a temperature sensor) reaches a first predetermined temperature, the fuel pump 132 may allow a second higher flow rate of fuel to the system. As the fuel/air mixture becomes richer, a controller may open the second valve 204 of the air inlet control system 103, to allow additional air to enter the system at a first increased air flow rate, thereby causing the engine to fire more vigorously. As the temperature of the HTF immediately downstream of the engine reaches a second predetermined temperature, the fuel pump may allow a third, even higher flow rate of fuel to the system. In order to match this fuel increase and in order to keep the engine operating efficiently, the third valve 206 may open, thereby allowing a second increased air flow rate to enter the system, thereby bringing the engine 110 to full power.

The values of air and fuel flow rates may vary depending on the external environmental conditions, the process fluid to be separated, the type of HTF used, the type of fuel used, or any other of a host of factors. As one non-limiting example of the use of the inlet control system, in the case of the process fluid to be evaporated comprising water, the HTF comprising Therminol 55, the fuel used comprising propane, and approximately 60° F. ambient conditions, the following process may be utilized. At starting conditions to begin idling of the engine, an initial air flow rate of 24 cfm may be applied at 100 psi, and the fuel may be introduced at 1.1 cfm. Once the temperature of the engine has reached 85° F. (such as may be measured by reading the Therminol 55 temperature immediately downstream from the engine), the propane flow rate may be increased to 1.8 cfm, and the air flow increased to 32 cfm at 100 psi. Once the engine temperature reaches 100° F., the engine may be brought to full throttle by increasing the propane flow rate to 2.2 cfm and the air flow rate to 50 cfm at 100 psi.

The controllers of the present system may comprise a series of controllers which may be coordinated with one another, or may comprise a single controller for controlling each of the functions outlined herein.

With further reference to FIG. 9, the system 100 may further include a chamber 160 for receiving the process fluid after it has been separated by the engine 110, such as into solids and a vaporized fluid. This chamber 160 may reduce the velocity of the dry or solid component and the high humidity exhaust gas or vaporized fluid, allowing the dry component to separate. In one embodiment, the exhaust from the engine 110 may be at least partially within the chamber 160, and the process fluid may be introduced into said exhaust within the chamber 160. This allows for maximum heat transfer to the material with minimal heat losses.

The chamber may be in the form of an expansion chamber, a heat recovery chamber, a drop box separator, or a fluidized bed dryer. In one aspect, the chamber may be insulated to retain heat in order to prevent vaporized fluid from condensing within the chamber 160, while allowing the solids to settle to the bottom of the chamber 160. The chamber may include a solids collection device 162, such as an auger for transferring solids separated from the vaporized fluid to a solids outlet 164. The output from this outlet 164 may be in the form of a dried slurry and/or solid particles.

The system may further include a secondary outlet 166 for transferring vaporized fluid and/or any airborne particulates from the chamber 160. The secondary outlet 166 may transfer the vaporized fluid and the airborne particulates to a dust collector 170, which may include an outlet 172 for removing the airborne particles and other dust particulates from the vaporized fluid. Further removal of solids may be accomplished via a cyclone and/or a filtering device such as a bag-house or cartridge collector. The vaporized fluid may be drawn through the system 100 via a blower 180, which may pass the remaining vaporized fluid to an exit 182 for discharge to the atmosphere, or to a liquid recovery condenser (not pictured) for condensing and recovering the vaporized fluid. The condenser may be utilized especially when a goal of the separation of the process fluid is for the recovery of clean water or other fluid.

In another embodiment, a collector may be used to collect one or more hazardous materials that may be separated through the use of the engine 110. For example, an activated carbon or zeolite adsorption bed may be used to collect one or more hazardous materials separated and traveling with the exhaust. These hazardous materials may include methane, benzenes, radionuclides, other radioactive particles, or any other potentially harmful product, and may be particularly effective in the separation of well drilling clay and liquids. The adsorption bed may be placed in the path of the exhaust from the engine 110 or at another point downstream therefrom so as to collect the desired hazardous material. The use of an adsorption bed may be used alone or in combination with a drying element, such as for removing a hazardous liquid or gas from the exhaust stream, while collecting a separated compound that had been previously dissolved or suspended therein.

In one aspect, the system 100 may include a fire suppression system 190 for the prevention of any unexpected fire that may be caused by the engine 110.

In a further aspect of the invention, the “squared” high pressure shock waves created by the invention herein may be used to create cavitation in the atomized droplets. This cavitation may be a result of the ultrasonic contribution. This may be used to enhance advanced oxidation of organic contaminants. Such advanced oxidation may be accomplished through the use of ultra violet light, ozone, peroxide, and/or an electric field.

In another aspect, the “squared” high pressure shock waves may be combined with a high voltage, such as with a wet electrostatic precipitator. The high voltage may impart charge to the atomized micro droplets of water. Such charged micro droplets may be utilized to scrub or remove ultra-fine particulate or smoke from an air stream. The droplet size and electrical charge can be adjusted within limits.

Another aspect of the invention includes use of the “squared” high pressure shock waves to de-salt water used for drinking water or irrigation.

Other applications of the present invention include utilizing the device to dry coal slurries. Additionally, the “squared” high pressure shock waves may be used to make ultra-fine powdered metals. This may include introducing molten metal into the exhaust of the device. Said molten metal may be introduced with or without an inert or reactive gas blanketing. Examples of powders that may be made include aluminum and/or magnesium powders. It is further contemplated that the “squared” high pressure shock wave device may be used in a partial vacuum.

While the disclosure presents certain embodiments to illustrate the inventive concepts, numerous modifications, alterations, and changes to the described embodiments are possible without departing from the sphere and scope of the present invention, as defined herein. Accordingly, it is intended that the present disclosure not be limited to the described embodiments, but that it has the full scope defined by the language of the following claims, equivalents thereof, and that which is in the purview of the ordinarily skilled artisan upon examination of the disclosure.

1. An apparatus for creating an exhaust stream for separating a fluid from a compound suspended or dissolved therein, said apparatus comprising:
a pulse jet engine; and
a rotary valve for selectively introducing pressurized pockets of air into the pulse jet engine.

2. The apparatus of claim 1, wherein the pulse jet engine includes a combustion chamber and an exhaust section, and wherein the compressed pockets of air are introduced into the combustion chamber.

3. The apparatus of claim 2, wherein the combustion chamber and the exhaust section are generally circular in cross-section, and wherein a diameter of the combustion chamber is different in size than a diameter of the exhaust section.

4. The apparatus of claim 1, further including an injector for mixing fuel with the pressurized pockets of air prior to introduction into the pulse jet engine.

5. The apparatus of claim 4, wherein the injector includes a conduit with a non-circular cross-sectional shape.

6. The apparatus of claim 5, wherein the conduit includes a floraform cross-sectional shape.

7. The apparatus of claim 1, wherein the rotary valve includes a rotor with a passage therethrough for selectively allowing pressurized air into the pulse jet engine.

8. The apparatus of claim 1, wherein the rotary valve includes an ignition system for selectively controlling an igniter associated with the pulse jet engine.

9. The apparatus of claim 8, wherein the ignition system comprises a magnet and a magneto coil, and wherein rotation of the rotary valve causes movement of one or the other of the magnet and the magneto coil such that relative motion between the magnet and the magneto coil generates sufficient voltage to cause the igniter to ignite.

10. The apparatus of claim 1, further including a nozzle for introducing the fluid and the compound suspended or dissolved therein into the exhaust stream from the pulse jet engine for separation.

11. A system for separating a fluid component from a process fluid including the fluid component and at least one other component, said system comprising:
a pulse jet engine including a combustion chamber and an exhaust;
a rotary valve for introducing pockets of pressurized air into the combustion chamber;
a fuel injection system for mixing fuel with the pressurized pockets of air prior to entering the combustion chamber; and
at least one conduit for introducing the process fluid into an exhaust stream at the exhaust of the pulse jet engine.

12. The system of claim 11, further including at least one first heat exchanger associated with the pulse jet engine for recovering heat created during combustion.

13. The system of claim 12, further including at least one second heat exchanger associated with the at least one conduit for preheating the process fluid prior to entering the exhaust stream.

14. The system of claim 11, further including at least one controller for controlling one or more of the rotary valve, the fuel injection system, and a flow rate of the process fluid through the at least one conduit.

15. The system of claim 11, further including a chamber for receiving the process fluid after it has been separated into the fluid component and the at least one other component by the exhaust stream.

16. The system of claim 15, wherein the chamber includes a solids collection device for collecting the at least one other component separated from the process fluid.

17. The system of claim 15, further including a pressurizing device for drawing the fluid component separated from the process fluid from the chamber.

18. A system for creating an exhaust stream for separating a fluid from a compound suspended or dissolved therein, said system comprising:
a pulse jet engine including a combustion chamber and an exhaust;
a rotary valve for introducing pockets of pressurized air into the combustion chamber;
a fuel injection system for mixing fuel with the pressurized pockets of air prior to entering the combustion chamber; and
an air inlet control system for controlling a flow rate of air introduced to the rotary valve.

19. The system of claim 18, wherein the air inlet control system includes a controller for varying the flow rate of air based on a temperature of the pulse jet engine.

20. The system of claim 19, wherein the air inlet control system includes at least two airflow pathways, and wherein the controller is adapted to selectively direct air through one or more of the pathways in response to a change in the temperature of the pulse jet engine.
